(19) United States
(12) Patent Application Publication
(10) Pub. No.: US 2024/0207019 A1
(43) Pub. Date: Jun. 27, 2024

(54) PATIENT-SPECIFIC INTRAORAL DENTAL GUIDANCE ASSEMBLY

(71) Applicants: Sergio SAMRANO, Allone Aba (IL); Eldar COHEN, Yokneam Illit (IL)

(72) Inventors: Sergio SAMRANO, Allone Aba (IL); Eldar COHEN, Yokneam Illit (IL)

(21) Appl. No.: 18/435,611

(22) Filed: Feb. 7, 2024

Related U.S. Application Data
(63) Continuation of application No. PCT/IL2022/050855, filed on Aug. 7, 2022.
(60) Provisional application No. 63/230,790, filed on Aug. 8, 2021.

(51) Int. Cl. A61C 7/00; A61C 7/08; A61C 9/00; G06T 17/00

(52) U.S. Cl. CPC A61C 7/002; A61C 7/08; A61C 9/0053; G06T 17/00

(57) ABSTRACT

A dental guidance assembly comprising: a rigid arcuate base sized and structuredconfigured to snugly fit over a dental arch of a specific human subject; a hinge fixedly mountable on relative to said rigid arcuate base; an arm having a proximal side and a distal side, said arm being pivotally connectable at its proximal side to said hinge, and connectable configured to support, at its distal side, to a dental rotary handpiece; and an exchangeable bur or file guide sized and structuredconfigured to snugly fit in said rigid arcuate base, said bur or file guide comprising a channel that is sized and structuredconfigured to guide a bur or a file mounted on the dental rotary handpiece along a preplanned treatment path in a treated tooth of the dental arch of the specific human subject.

### CROSS-REFERENCE TO RELATED APPLICATIONS

This application is a bypass continuation of PCT/IL2022/050855 filed Aug. 7, 2022, which claims the benefit of priority of U.S. Provisional Patent Application No. 63/230,790, filed Aug. 8, 2021, entitled “Patient-Specific Intraoral Dental Guidance Assembly,” the contents of which are incorporated herein by reference in their entirety.

### FIELD OF THE INVENTION

The invention relates to the field of dental instruments.

### BACKGROUND

Dental treatment often involves drilling, cutting, filing, reshaping and other types of machining of the teeth, all done in the limited intraoral space of the patient. The most commonly used method by dentists is to survey the treatment area visually, and then manually use a rotary handpiece, with a suitable bur or file, according to the visual inspection. Such manual operation, however, requires skill, stability, and concentration.

In addition, although diagnostic X-Rays or even Cone-Beam Computed Tomography (CBCT) images are taken prior to many procedures, dentists may still find it hard to translate what they observe in these images into exact coordinates of handpiece operation, and therefore have to use some explorative drilling until they can determine what exact areas of the tooth have to be removed.

The foregoing examples of the related art and limitations related therewith are intended to be illustrative and not exclusive. Other limitations of the related art will become apparent to those of skill in the art upon a reading of the specification and a study of the figures.

### SUMMARY

The following examples and aspects thereof are described and illustrated in conjunction with systems, tools and methods which are meant to be exemplary and illustrative, not limiting in scope.

One example relates to a dental guidance assembly comprising: a base configured to fit over a dental arch; a hinge mountable relative to said base; an arm pivotally connectable to said hinge, and configured to support a dental rotary handpiece; and one or more an exchangeable bur or file guides configured to fit in said base and to guide a bur or a file mounted on the dental rotary handpiece along a preplanned dental treatment path.

A more specific example provides a dental guidance assembly comprising: a rigid arcuate base configured to snugly fit over a dental arch of a specific human subject; a hinge fixedly mountable relative to said rigid arcuate base; an arm having a proximal side and a distal side, said arm being pivotally connectable at its proximal side to said hinge, and configured to support, at its distal side, a dental rotary handpiece; and an exchangeable bur or file guide configured to snugly fit in said rigid arcuate base, said bur or file guide comprising a channel that is configured to guide a bur or a file mounted on the dental rotary handpiece along a preplanned treatment path in a treated tooth of the dental arch of the specific human subject.

Optionally, the dental guidance assembly further comprises: a rigid reinforcement frame configured to snugly fit over said rigid arcuate base, wherein said hinge is fixedly mountable on said rigid reinforcement frame.

Optionally, the dental guidance assembly comprises multiple ones of said exchangeable bur or file guide.

Optionally, said multiple exchangeable bur or file guides are two or more of: a first exchangeable bur or file guide whose channel is a tubular channel configured to limit motion of the bur or file to linear drilling or filing into the treated tooth; a second exchangeable bur guide whose channel is an clongated slot configured to limit motion of the bur to circumferential cutting of a crown of the treated tooth; a third exchangeable bur guide whose channel is a wide tubular channel configured to limit motion of the bur to removal of an upper layer of the crown of the treated tooth; and a fourth exchangeable bur guide whose channel is a wide tubular channel configured to limit motion of the bur to drilling of an upper opening in the crown of the treated tooth. The dental guidance assembly is configured for exchanging of said multiple exchangeable bur or file guides by one another while said rigid arcuate base, optionally said rigid reinforcement frame, said hinge, and said arm are assembled together and are secured intraorally.

Optionally, said arm further comprises a dental rotary handpiece interface at its distal side, said interface configured to interface with a head of the dental rotary handpiece.

Optionally, said hinge is a first hinge; said arm is a first arm; and the dental guidance assembly further comprises: a second hinge fixedly mountable relative to said rigid arcuate base, and a second arm having a proximal side and a distal side, said second arm being pivotally connectable at its proximal side to said second hinge, and being configured to support, at its distal side, the dental rotary handpiece.

Optionally, said rigid arcuate base includes a void where a tooth to be treated is to be located when said rigid arcuate base is fit over the dental arch; and said exchangeable bur or file guide is configured to snugly fit in said void.

Another example is directed to a method for using the dental guidance assembly, the method comprising: fixedly mounting said hinge relative to said rigid arcuate base; pivotally connecting said arm, at its proximal side, to said hinge; snugly fitting said rigid arcuate base over the dental arch of the specific human subject; snugly filling said exchangeable bur or file guide in said rigid arcuate base; and while the dental rotary handpiece is supported by the arm and optionally by the second arm, guiding the bur or the file is said channel, to treat the tooth along the preplanned treatment path.

A further example is directed to a kit comprising: (a) a computer-aided design (CAD) software provided on a non-transitory computer-readable storage medium having program code embodied therewith, the program code executable by at least one hardware processor to: obtain a three-dimensional (3D) model of a dental arch of a human subject, the dental arch including a tooth to be treated; generate, respective of the 3D model of the dental arch, a 3D model of an arcuate base configured, once fabricated (as a rigid arcuate base), to snugly fit over the dental arch, the arcuate base having a void where the tooth is to be located when the arcuate base is fit over the dental arch; generate, respective of the 3D-modeled tooth and of a treatment plan, a 3D model of an exchangeable bur or file guide configured, once fabricated, to snugly fit in the fabricated arcuate base, wherein the 3D model of the bur or file guide comprises a channel that is configured, once fabricated, to guide a bur or a file mounted on a dental rotary handpiece along a preplanned treatment path in the tooth; (b) one or more rapid manufacturing machines configured to fabricate the arcuate base and the exchangeable bur or file guide based on the 3D models of the arcuate base and the exchangeable bur or file guide, respectively; (c) a hinge fixedly mountable relative to said arcuate base; and (d) an arm having a proximal side and a distal side, said arm being pivotally connectable at its proximal side to said hinge, and configured to support, at its distal side, a dental rotary handpiece.

Yet another example relates to a method for designing said rigid arcuate base and said exchangeable bur or file guide, comprising operating a computer-aided design (CAD) software to: obtain a three-dimensional (3D) model of the dental arch of a human subject, the dental arch including the tooth to be treated; generate, respective of the 3D model of the dental arch, a 3D model of said rigid arcuate base; generate, respective of the 3D-modeled tooth and of a treatment plan, a 3D model of said exchangeable bur or file guide.

Any of the options mentioned above for the dental guidance assembly example may also apply, mutatis mutandis, to the subsequent examples, of the methods and the kit.

In addition to the exemplary aspects and embodiments described above, further aspects and embodiments will become apparent by reference to the figures and by study of the following detailed description.

### BRIEF DESCRIPTION OF THE FIGURES

Exemplary embodiments are illustrated in referenced figures. Dimensions of components and features shown in the figures are generally chosen for convenience and clarity of presentation and are not necessarily shown to scale. The figures are listed below.

FIGS. 1A-1G show an exemplary dental guidance assembly in a front perspective view, rear perspective view, front isometric view, rear isometric view, top isometric view, bottom isometric view, and front isometric exploded view, respectively.

FIG. 2A shows an exemplary complementary bur guide in a front perspective view.

FIGS. 2B and 2C show an exemplary file guide in a front perspective view and a top isometric view, respectively.

FIG. 2D shows an exemplary bur/file guide configured to protect the gingiva, in a cross-sectional view.

FIG. 3 shows another exemplary dental guidance assembly in a front perspective view.

FIGS. 4A and 4B show a further exemplary dental guidance assembly in a front perspective view and an exploded perspective view, respectively.

FIG. 5 shows a block diagram of an exemplary system for dental treatment planning and generation of patient-specific dental guidance assemblies.

### DETAILED DESCRIPTION

A patient-specific dental guidance assembly (hereinafter “assembly”) is disclosed herein. The assembly, advantageously, may be supported entirely intraorally, and be configured to guide drilling, filing, and/or cutting operations of a tooth along one or more preplanned treatment paths. This guidance may be facilitated by an interplay between at least one arm that limits motion of a dental rotary handpiece (hereinafter “handpiece”), and a bur or file guide that includes a channel configured (namely, sized and structured) according to the preplanned treatment path. This interplay may limit motion of the handpiece, and therefore of the bur or file, to multiple (e.g., three) predefined degrees of freedom.

Advantageously, two or more exchangeable bur or file guides may be provided, and be exchanged during treatment to facilitate different preplanned treatment paths of the same tooth.

In one example of the dental guidance assembly, it may include the following components: a rigid arcuate base configured to snugly fit over a dental arch of a specific human subject; hinge fixedly mountable relative to the rigid arcuate base (either mounted directly onto that base or indirectly, mounted onto a rigid reinforcement frame that in turn fits over the base); an arm having a proximal side and a distal side, the arm being pivotally connectable at its proximal side to the hinge, and connectable at its distal side to a dental rotary handpiece; and an exchangeable bur or file guide configured to snugly fit in the base, and including a channel that is configured to guide a bur or a file mounted on the dental rotary handpiece along a preplanned treatment path in a treated tooth of the dental arch of the specific human subject.

Advantageously, at least some parts of the assembly may be fabricated specifically for a certain patient using computer-controlled rapid manufacturing, in accordance with a three-dimensional (3D) model of that patient's relevant dental structures and a computerized treatment plan prepared by a dentist (or according to the dentist's instructions) respective of the 3D model. Other parts of the assembly may be universal, namely—fabricated in only one or a few sizes using mass-manufacturing techniques, and structured to fit and be mounted with the patient-specific parts.

The assembly may be useful, for example, in endodontic treatment, which typically includes three stages of tooth matter removal: drilling of a top opening in the tooth, typically with an access bur; removing infected tissue from the upper areas of the root canals while widening these areas, typically with a discovery/exploration bur; and cleaning the lower areas of the root canals from infected tissue, typically with a flexible filer.

In this and other multi-stage treatment scenarios, each of the multiple bur or file guides may be fabricated to facilitate a different stage of treatment, in accordance with the 3D model and the dentist's treatment plan. These bur or file guides can then be quickly and conveniently exchanged during treatment, while the majority of the assembly remains secured in the patient's mouth.

A further type of treatment which may benefit from the assembly is a reshaping of a tooth's crown with a suitable bur to prepare a circumferential shoulder that supports the mounting of an artificial crown. This is sometimes done also in endodontic treatments.

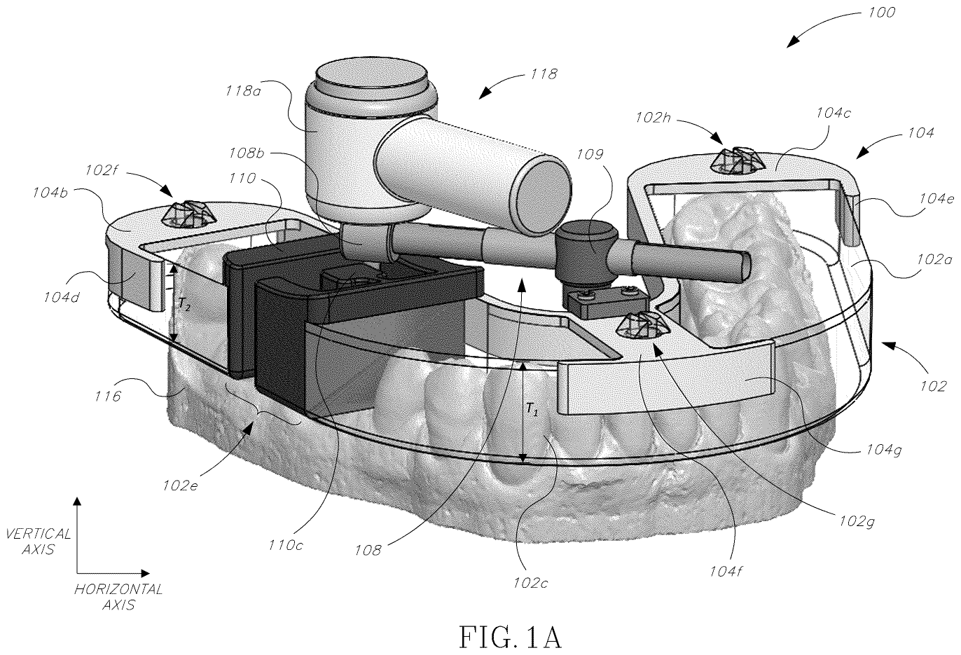

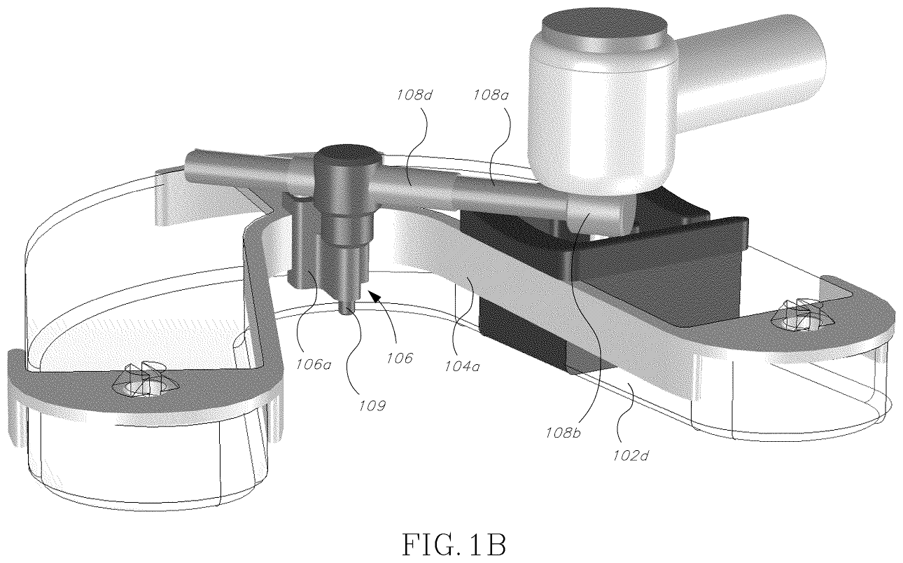

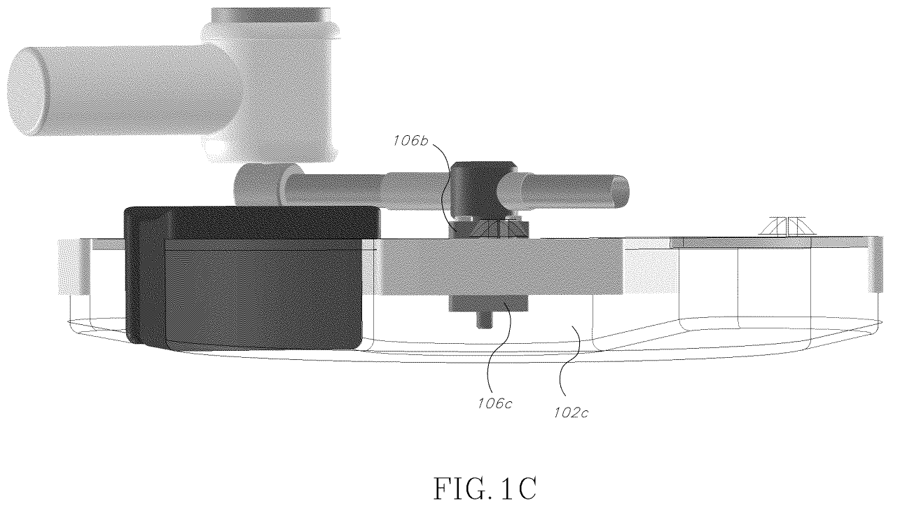

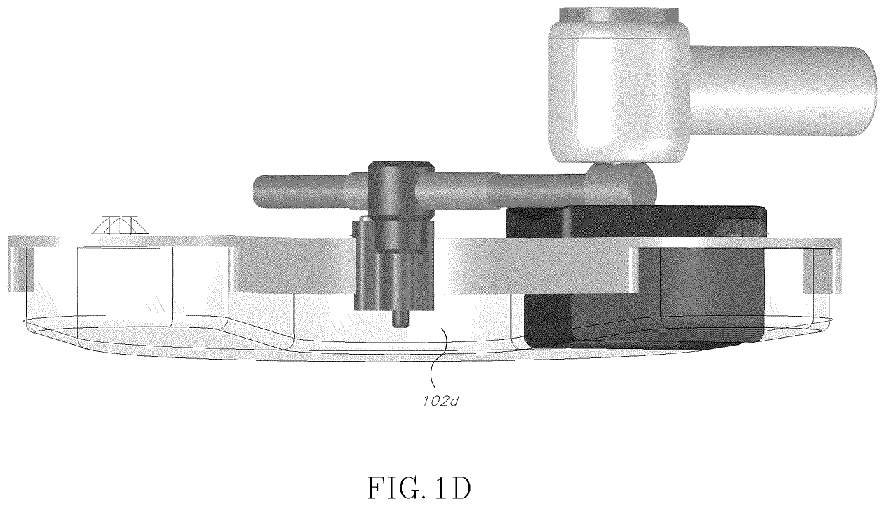

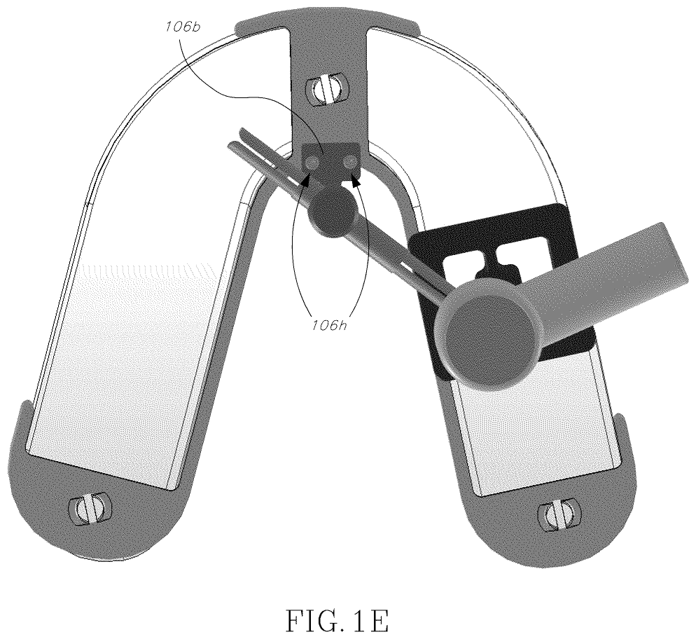

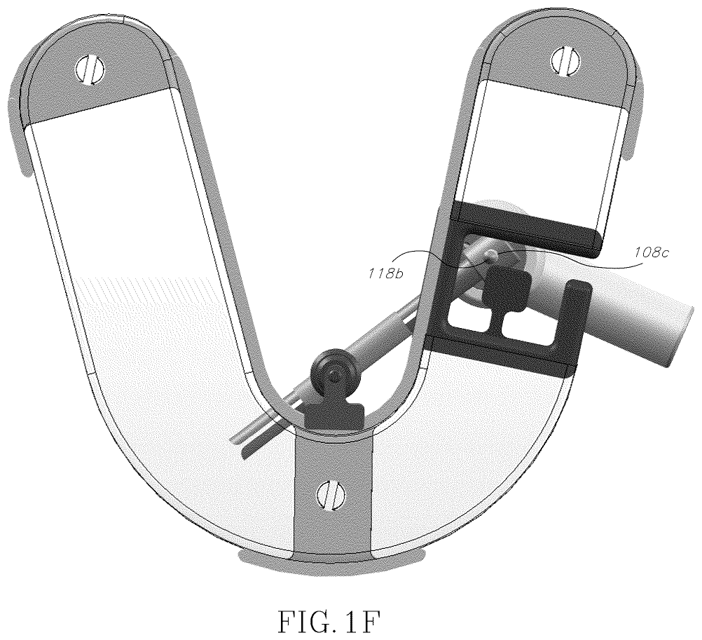

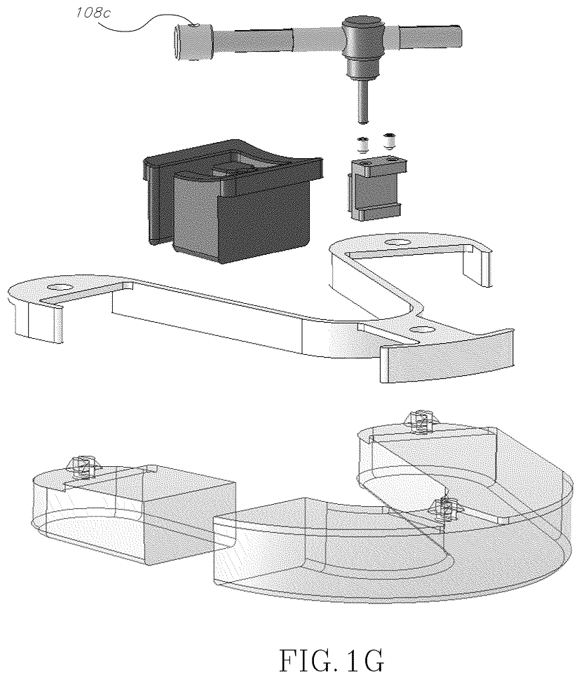

Reference is now made to FIGS. 1A-1G, which show an exemplary assembly 100 in a front perspective view, rear perspective view, front isometric view, rear isometric view, top isometric view, bottom isometric view, and front isometric exploded view, respectively, in accordance with some examples. In favor of enhanced clarity: black lines marking part edges and curvature edges are shown; an exemplary dental arch (along with some gums) 116 of a patient is shown only in FIG. 1A; an exemplary handpiece 118, not forming part of the assembly, is shown in all these figures; and a base 102 is shown as a translucent object so that its surrounding parts can be better seen.

For reasons of simplicity, assembly 100 is shown and discussed in association with a mandibular dental arch, to which it is made to fit; however, these discussions are also explicitly intended to apply, with the necessary changes, to an assembly made to fit a maxillary dental arch. Accordingly, various directional terms relating to assembly 100 and to dental arch 116, such as “upper,” “lower,” and others, should be read inversely for an assembly intended for the maxillary dental arch.

Assembly 100 may generally include a rigid arcuate base (hereinafter “base”) 102, a rigid reinforcement frame (hereinafter “frame”) 104, a hinge 106, an arm 108, and an exchangeable bur guide (hereinafter “bur guide”) 110.

Base 102 may be shaped as a volumetric arch having a substantially planar upper surface 102a, a lower surface 102b with indentations matching the crown shapes of at least some of the teeth of dental arch 116, and substantially parallel front 102c and rear 102d surfaces which surround the facial and lingual sides, respectively, of the dental arch.

One or both of front 102c and rear 102d surfaces may be substantially perpendicular to upper surface 102a (or to an average plane of the upper surface, in case it is not completely planar).

Base 102 may have a varying thickness along its arcuate aspect, between its upper 102a and lower 102b surfaces (not counting the teeth-shaped indentations). The thickness may be greater at the middle of the arch (T₁) and lesser at the two ends of the arch (T₂), to account for the typical height variance of tooth crowns—taller in the incisors and shorter at the molars. T₁ is optionally between 7-18 (millimeters), and T2 between 3-14 mm. Smaller or larger values are also possible. The thickness of base 102 may be suited to the crown heights of the patient, with typically smaller sizes for children and larger sizes for adults. Generally, the thickness of base 102 may be made to cover at least half of the height of the crowns (on average), and optionally the entirety of their height or even slightly more (extending slightly downwardly over the gums)—all while leaving a sufficient thickness of base material above the crowns (e.g., at least 0.5 mm above the tallest crown) in favor of structural strength.

In an alternative configuration (not shown), the thickness of the base (not counting the teeth-shaped indentations) is uniform along its arcuate aspect.

Base 102 may have a void 102e over where a tooth to be treated (hereinafter the “treated tooth”) is to be located when the base is fit over the patient's dental arch, in this example—the right mandibular first molar (not seen). Bur guide 110 may snugly fit in that void. In the exemplary base 102 shown, the void is a full missing segment in the base's arcuate shape. Namely, base 102 is comprised of two physically separate parts disposed on the mesial and distal sides of the treated tooth, and being held together by frame 104, as discussed further below.

In an alternative configuration (not shown), the base is a single physical unit, and the void is a full-thickness (top to bottom) cutout in the base, which still leaves some material to make up a rear wall or a front wall (bordering the rear surface or the front surface, respectively) of the base next to the cutout. For example, a rear or front wall thickness of 0.5-4 mm may interconnect the two sides of the base opposite the cutout.

In either case, the opposing surfaces of the void (mesially and distally of the treated tooth) may be parallel or substantially parallel, and each of them may be perpendicular or substantially perpendicular to upper surface 102a (or to an average plane of the upper surface, in case it is not completely planar).

Base 102 may include one or more connectors for snugly securing it to frame 104. In the illustrated example, these are three resilient, self-locking, split pin connectors 102f-h disposed on upper surface 102a, that are optionally integrally formed with base 102. Two connectors 102f and 102h may be located near the two opposing ends of upper surface 102a, and one connector 102g at around the center of the upper surface. The illustrated number, type, and location of connectors is merely an example, of course. Upper surface 102a may be slightly depressed around the connectors, as seen especially in FIG. 1G, to receive in these depressed areas portions of frame 104 without these portions protruding upwardly from the upper surface, as will be discussed further below.

Base 102 may be fabricated specifically for a certain patient using a computer-controlled rapid manufacturing machine which uses additive or subtractive manufacturing techniques. Prominent examples include 3D printing and CNC (Computer Numerical Control) milling. Such suitable rapid manufacturing machine may be conveniently installed in the dentist's clinic or in a nearby facility, for example.

Base 102 may be made of one or more materials such as plastics, metals, and ceramics. Exemplary plastics include ABS (Acrylonitrile Butadiene Styrene), PLA (Polylactic Acid), Carbon Fiber PLA, PVA (Polyvinyl Alcohol), PET (Polyethylene Terephthalate), PETG (Glycol-modified PET), PETT (Polyethylene coTrimethylene Terephthalate), HIPS (High Impact Polystyrene), Polyamide (“Nylon”), Amphora 3D, ASA (Acrylonitrile Styrene Acrylate), and others. Exemplary metals include stainless steel, cobalt-chrome alloy, titanium, nickel-titanium alloy (nitinol), and others.

In preparation of fabricating base 102, a computerized 3D model of the patient's pertinent dental arch may be constructed, by conventional techniques, from 3D imagery of the dental arch, such as Cone-Beam Computed Tomography (CBCT) imagery.

Specialized Computer-Aided Design (CAD) software, provided in accordance with an example, may be used to generate, respective of the dental arch's 3D model, a Computer-Aided Manufacturing (CAM) file and/or a 3D model representative of base 102, which may then be fed to the machine for manufacturing. This CAD software may either be a standalone software application, or an add-on (also “plug-in”) to a conventional CAD application that endows that conventional CAD application with the capabilities discussed herein.

The software may include program code characterizing the general structure of base 102, minus the indentations in its lower surface 102b and minus the void 102e. For example, the program code may characterize a number of such general structures, differing by size (e.g., for small, medium, and large dental arches) and/or by their correspondence to typical dental arch morphologies (e.g., “oval,” “square,” “conical,” as defined in the medical literature). For instance, between 3 and 15 such general structures may be defined in the software (or any number exceeding that range). This will allow providing every dentist who wishes to use the invention with a small stock of different frames of the likes of frame 104, that are fabricated by mass-manufacturing techniques from a material (or multiple materials) which cannot be practically or reliably fabricated by the rapid manufacturing machine used by the dentist. These frames may be provided in various standard structures, corresponding to the number of general base structures defined in the software, such that a mass-manufactured frame of a certain structure can be snugly fit over, and be secured to, a patient-specific base of a corresponding general structure.

The general base structures included with the software may also define structures and locations of the connectors, such as connectors 102f-h, to match corresponding mating structures (such as apertures) in the different provided frames.

The software may either automatically select a general base structure based on the 3D model of the dental arch, or the selection may be made manually by the person operating the software, such as the dentist, a dental technician, or any other expert. Automatic selection, if used, may include an automatic determination as to which of the general base structures has an inner volume configured (namely, sized and structured) to accommodate therein the crowns (to the entire extent of their heights, or less, as discussed above) of all teeth of the dental arch (or a smaller subset thereof, if base 102 is to be fabricated to fit over fewer teeth), with a sufficient distance remaining between the facial surfaces of the teeth and front surface 102c, between their lingual surfaces and rear surface 102d, and between their incisal and occlusal surfaces and upper surface 102a. That sufficient distance may be a predefined value between 0.5-4 mm, for example, which may be the same or different for the three surfaces. These values are optionally adjustable by the person operating the software. As to the thickness of base 102, the various possibilities and considerations were discussed above.

Once a general base structure has been selected, the software may automatically design the indentations in lower surface 102b to inversely match the 3D model of the dental arch, such that the fabricated base 102 will snugly fit over the specific patient's dental arch. The design may then be fine-tuned, if desired, by the operator of the software. The indentations may be designed to cover the teeth up to a predefined distance below the undercuts of at least some of the teeth (e.g., 0.5-3 mm below the undercuts), in order for base 102 to clamp onto these teeth and remain retained by these undercuts. This is especially useful if base 102 is to be used for the maxillary dental arch, where the base will not remain fitted on the arch merely by gravity. The extent of tooth coverage by the indentations in base 102 may be determined according to known principles of removable orthodontic appliance design.

The software may also automatically define, in the design, a location, size, and shape of the void 102e in base 102, respective of an indication by the operator of the software as to which is the treated tooth. The design of the void 102e may also be fine-tuned, if desired, by the operator of the software. This stage of the design can be regarded as part of a computerized treatment plan prepared by the dentist (or according to the dentist's instructions), further discussed below with reference to bur guide 110 (which is also rapidly manufactured per patient).

Next discussed is frame 104. In order to support arm 108 on a highly-stable foundation that will ensure that handpiece 118 is limited to the one or more defined degrees of freedom, frame 104 may be provided as a reinforcement to base 102. Frame 104 may be made, for example, of a stiff metal or metal alloy, which, when snugly fit over base 102 and firmly secured to it, can stably support arm 108 and handpiece 118 as the handpiece is being moved by the dentist. Frame 104 may include structures that encompass at least a portion of rear wall 102d, at least a portion of front wall 102c, and at least a portion of upper wall 102a.

Frame 104 may be a unitary piece of material which includes, for example, an arcuate wall 104a extending over the majority or the entirety of the arcuate aspect of rear surface 102d of base 102. Near each of the two opposing ends of rear surface 102d, the frame may include a bridge 104b/104c passing over upper surface 102a of base 102 to its frontal side, where a flange 104d/104e lies flush with front surface 102c of the base. Bridges 104b and 104c may fit in the respective depressed areas in upper surface 102a of base 102, optionally without protruding upwardly from the thicker middle area of the upper surface.

Another bridge 104f may extend from arcuate wall 104a over upper surface 102a of base 102 at around the centers of frame 104 and the base, and terminate with another flange 104g that lies flush with front surface 102c of the base.

Each of bridges 104b, 104c, and 104f, may include a mating structure configured to securely attach to one of connectors 102f, 102h, and 102g, respectively, such as in the form of apertures in the bridges through which the self-locking split pins can be inserted and locked.

A height of arcuate wall 104a and flanges 104d, 104e, and 104g may be less than the thickness of base 102 at its respective areas, such that the lower edge of the arcuate wall and the flanges does not protrude downwardly from the base and injure the gums. For example, the height of arcuate wall 104a and flanges 104d, 104e, and 104g may be between 50-100% of the thickness of base 102, and may be variable or uniform depending on whether the thickness of the base is variable or uniform.

Frame 104 may have a uniform or a varying thickness along its arcuate wall 104a, bridges 104b, 104c, and 104f, and flanges 104d, 104e, and 104g, of between 0.5-2 mm or beyond.

Frame 104 may be made of one or more materials such as plastics, metals, and ceramics, that are highly-stiff. Exemplary plastics include ABS (Acrylonitrile Butadiene Styrene), PLA (Polylactic Acid), Carbon Fiber PLA, PVA (Polyvinyl Alcohol), PET (Polyethylene Terephthalate), PETG (Glycol-modified PET), PETT (Polyethylene coTrimethylene Terephthalate), HIPS (High Impact Polystyrene), Polyamide (“Nylon”), Amphora 3D, ASA (Acrylonitrile Styrene Acrylate), and others. Exemplary metals include stainless steel, cobalt-chrome alloy, titanium, nickel-titanium alloy (nitinol), and others.

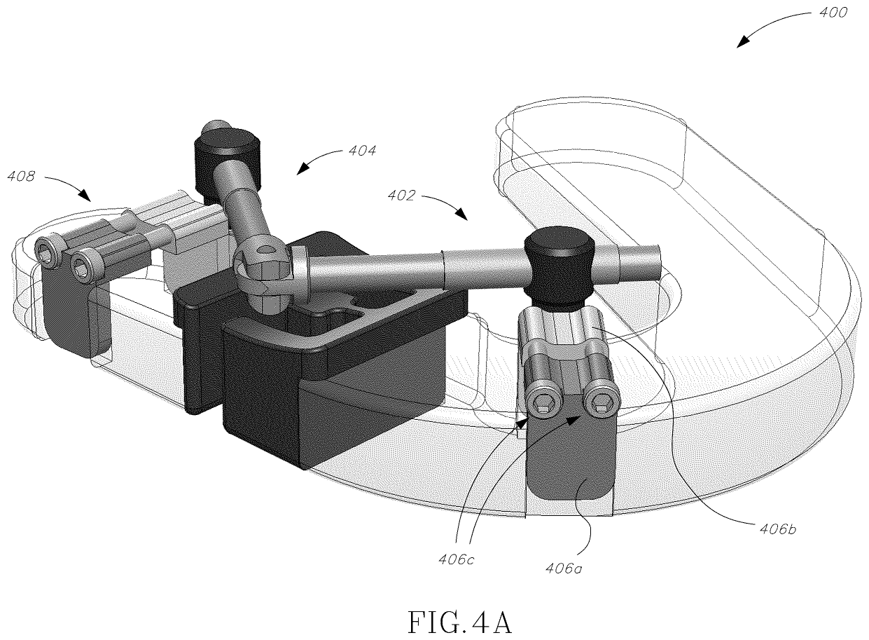

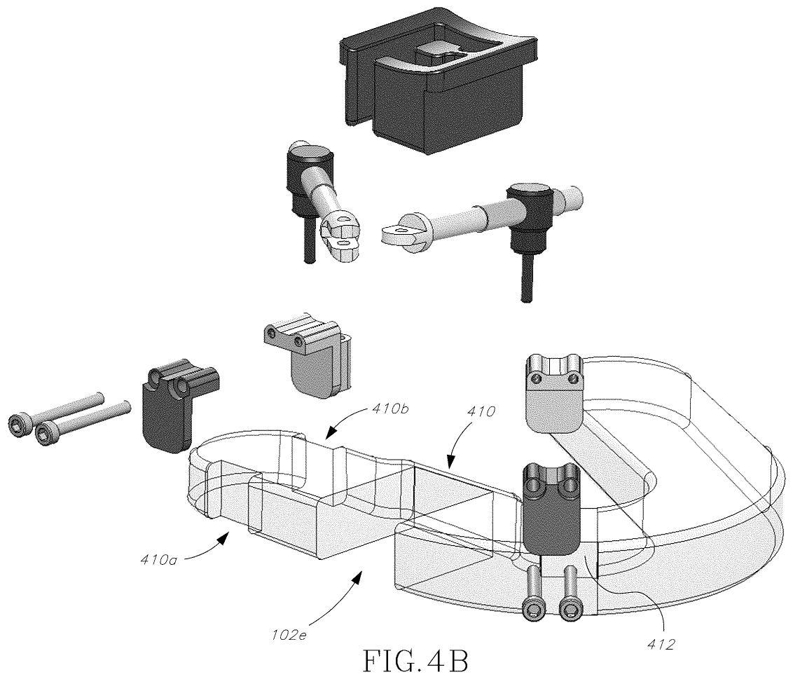

Optionally, if base 102 is sufficiently rigid and stable, assembly 100 does not include a frame such as frame 104. Instead, hinge 106 may be configured to be mounted directly onto base 102, without an intermediate frame. This resembles the direct mounting of clamps onto a base in the configuration discussed below with reference to FIGS. 4A and 4B.

Next discussed is hinge 106. To facilitate pivotal connection of arm 108 to frame 104, a fixedly mountable hinge 106 may be provided, optionally as a unitary piece of highly-stiff material such as a metal or metal alloy. Hinge 106 may be mass-manufactured, according to the same rationale of frame 104—to provide the dentist with a small stock of hinges that will fit any type of patient-specific base 102 and bur guide 110.

Hinge 106 may include an arcuate vertical wall 106a whose arcuacy matches that of rear wall 102d of base 102 at the area where the hinge is to be mounted, such as at or around the center of the rear wall of the base. Perpendicularly to vertical wall 106a, at its top and bottom, are an upper flange 106b and a lower flange 106c, respectively, having a vertical distance between them that matches the height of frame 104 at the area of mounting.

To mount hinge 106 to frame 104, lower flange 106c is placed under arcuate wall 104a of the frame, and upper flange 106b is placed over bridge 104f of the frame, to snugly encompass the frame at that location from three sides. Upper flange 106b of hinge 106 may include a mechanism to secure the hinge to frame 104, such as the illustrated pair of holes and their associated screws 106h that either attach to the frame by friction or forced indentation, or fit into mating structures in the frame (e.g., pre-fabricated depressions or threaded bores, not shown).

In an alternative configuration (not shown), the hinge may be structured differently, but still be configured to be secured to frame by fixedly clamping onto it.

Hinge 106 may include a vertical tube 106d adjacent vertical wall 106a, which tube is configured (namely, sized and structured) to pivotally house a cylindrical axle 109 disposed at a proximal side of arm 108. Axle 109 may include, above its thinner cylindrical part that fits into hinge 106, a thicker part that prevents it from sliding fully through the hinge, and enables it to receive a horizontal rod 108a of arm 108.

Horizontal rod 108a of arm 108 optionally has a circular cross-section, and is threaded, at a proximal side of the arm, through a matching hole at the top of axle 109. This pivotally connects arm 108 to frame 104. An optional sleeve 108d may be disposed around horizontal rod 108a, along a portion of the length of the horizontal rod, such that the sleeve is the one engaging the inner walls of the hole at the top of axle 109.

At the distal side of horizontal rod 108a, arm 108 may include a handpiece interface 108b that enables it to connect to or support a head 118a of handpiece 118. Handpiece interface 108b may be fixedly attached to horizontal rod 108a or integrally formed with it, and include a bore 108c through which a bur 118b or a filer (not shown) can be threaded in order to access the treated tooth. Bore 108c may extend vertically from handpiece interface 108b, so as to limit vertical motion of bur 118b to the vertical axis of assembly 100. Alternatively, bore 108c may be disposed at an angle of, for example, 0.5-45°, relative to the vertical axis, to allow drilling, cutting, and/or filing of the treated tooth at a desired angle of access, which also corresponds to bur guide 110, as will be discussed below.

Optionally, handpiece interface 108b may configured to be rotated about a central axis of horizontal rod 108a of arm 108 and fixed at a desired angle of such rotation, so as to adjust the angle of bore 108c relative to the vertical axis of assembly 100 and set it as desired. In either case, when the posture of handpiece interface 108b is fixed, motion of bur 118b is limited to the central axis of bore 108c.

Arm 108 may be telescopic, namely—it may allow a changing of the distance between axle 109 and handpiece interface 108b, responsive to motion of handpiece 118 by the dentist. For example, horizontal rod 108b (optionally with sleeve 108d) of arm 108 may freely slide through the hole at the top of axle 109, to adjust the distance. In a different configuration (not shown), the telescopic operation of the arm may be achieved using a different structure, such as an outer tube and an inner tube sliding relative to one another, or the like.

Arm 108 and axle 109 may be mass-manufactured, according to the same rationale of frame 104 and hinge 106—to provide the dentist with a small stock of arms and axles that will fit any type of patient-specific base 102 and bur guide 110.

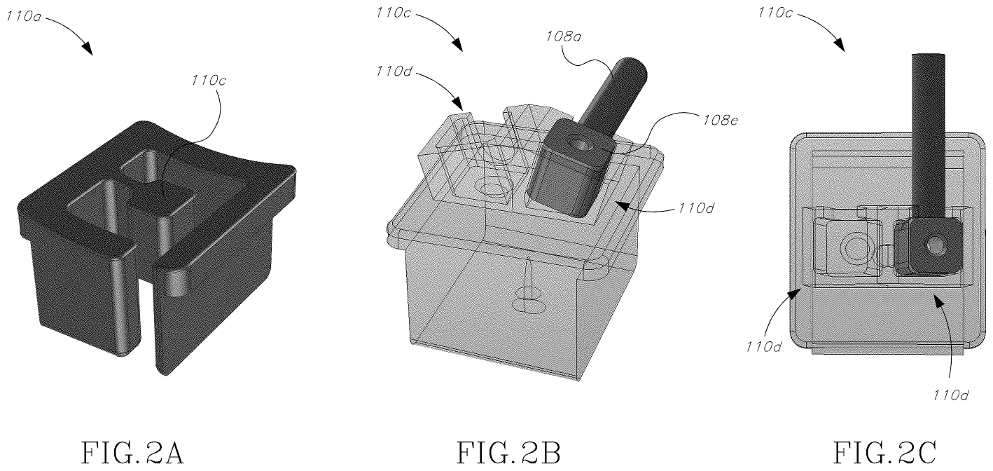

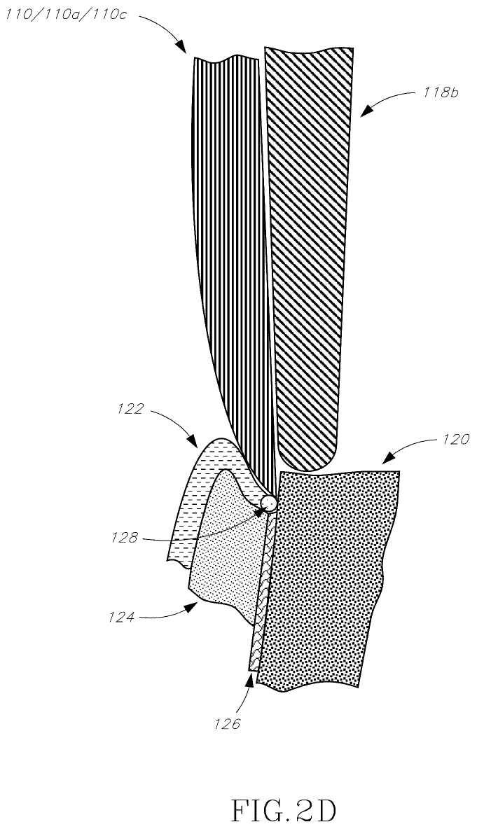

Next discussed is bur guide 110. Reference is also made to FIG. 2A, which shows an exemplary complementary bur guide 110a in a front perspective view, and to FIGS. 2B-2C, which show an exemplary file guide 110c in a front perspective view and a top isometric view, respectively. These bur/file guides exemplify the advantageous feature of providing various different guides with assembly 100, and exchanging them during treatment to facilitate different treatment stages. For example, file guide 110c may be used to guide a flexible file (mounted in handpiece 118, not shown) separately into each of the root canals of the treated tooth, while bur guide and 110 and complementary bur guide 110a may be used to guide a bur along a circumferential path in the crown of the treated tooth, to prepare a shoulder for mounting of an artificial crown.

One or more additional bur/file guides (not shown) may be provided with assembly 100, to guide a bur/file along various preplanned treatment paths, such as: a path that causes a bur to remove a top layer of the treated tooth (shortening the tooth); a path that that causes a bur (typically, an access bur) to drill a top opening in the treated tooth, in order to provide access to the tooth's pulp; and/or a path that causes a bur (typically a discovery/exploration bur) to remove infected tissue from the upper areas of the root canals while widening these areas by a desired amount.

All these shown and unshown bur/file guides may be generally box-shaped, configured (namely, sized and structured) to snugly fit in the void 102e of base 102, over the treated tooth. These general box shapes may include a rim around their upper surface, at least at the upper surface's mesial and distal sides, that engages with upper surface 102a of base 102 and prevents the bur/file guide from sliding downwards through the void 102e.

With reference to bur guide 110 and complementary bur guide 110a, they may each have an internal labyrinth structure which defines a limited motion path for bur 118b. The motion path is defined between walls of the guide's internal structure, and may have a breadth slightly larger (e.g., by 5-20%) than a maximal diameter of bur 118b, to allow the dentist to conveniently slide the bur along the path. Alternatively, the path may be broader than that, as defined by a treatment plan, to accommodate a different pattern of tooth reshaping.

To reshape the treated tooth along the entire circumference of its crown, a single bur guide may not be enough, because a closed circular treatment path requires not only peripheral limitation of the bur's motion but also central limitation; a central delimiter, however, must be somehow physically supported, and this is not possible if a closed circular treatment path around the central delimiter is desired. Accordingly, bur guide 110 and complementary bur guide 110a may be designed to cooperate in completing a closed circular treatment path: First, the dentist may position bur guide 110 in base 102, and use it to form a shoulder along a portion of the treated tooth's crown, such as in a U shape. Then, the dentist may remove bur guide 110 and exchange it with complementary bur guide 110a, which is designed with a complementary structure that allows the dentist to complete the formation of the shoulder along the remaining portion of the treated tooth's crown.

Optionally, the motion paths defined by the respective labyrinth structures of bur guide 110 and complementary bur guide 110a are partially overlapping, such as two opposing U shapes. Notably, each of bur guide 110 and complementary bur guide 110a has a central delimiter 110c that is supported from one of the side walls of the respective guide. Also, each of bur guide 110 and complementary bur guide 110a may have a front opening to the labyrinth structure, from which bur 118b may be inserted into the labyrinth while already inserted, to the full extent possible, through bore 108c of arm 108.

Each of bur guide 110 and complementary bur guide 110a may also be designed to control a penetration depth of the bur along the motion path, according to a treatment plan. To this end, the vertical walls that form the labyrinth structure may extend to predefined elevations above base 102, which correspond to the known length of the bur that is to be used, the height at which arm 108 holds handpiece 118 above the treated tooth, and the desired depth pattern of the tooth reshaping, drilling, etc. For example, bur guide 110 and complementary bur guide 110a are each shown with vertical walls which form, at their tops, an overall concave shape. This will cause the formed shoulder to have a similar concavity.

Optionally, one or more of bur guide 110, complementary bur guide 110a, and file guide 110c may have a lower curvature, defined by its lower surface or lower ends of its internal walls, that negatively matches the outer curvature of the treated tooth (pre-treatment). This way, the respective bur/file guide also snugly fits over the treated tooth, and the tooth itself provides it with additional support and stability, beyond the support by base 102.

With reference to file guide 110c, it may be structured as a fully- or partially-solid body having one or more (in this example, two) tubular channels extending from its top surface to its bottom surface. The diameter of these channels may be selected according to the maximal diameter of the file or files that are to be used. For example, each channel may have a diameter 5-20% larger than that of the file(s). The channels may be straight or curved. A curved channel may guide the inserted flexible file into the root canal at a different angle than its angle of insertion into file guide 110c.

Optionally, file guide 110c further includes at least one (in this example, two) cradle 110d at its upper surface, one over each channel opening, that are configured (namely, sized and structured) to snugly receive therein a handpiece interface such as handpiece interface 108b of FIGS. 1A-1G, or a non-circular (box-shaped) handpiece interface 108c. Cradle 110d may prevent motion of the bur or file in any direction except along an axis of the tubular channel inside file guide 110.

Each of the bur/file guides may be configured (namely, sized and structured) such that its bottom circumference protects the gingiva around the treated tooth from the bur or file used with the dental handpiece. Reference is now made to FIG. 2D which illustrates this in a cross-sectional view. Optionally, before positioning bur guide 110, complementary bur guide 110a, or file guide 110c over a tooth to be treated 120, a conventional gingival retraction cord 128 may be wrapped around the tooth and pushed into the gingival sulcus, to expose more of the tooth's lower circumference. The gingival retraction cord is optionally pre-soaked in a blood vessel constriction agent, such as an Aluminum-Chloride solution, both to prevent gingival bleeding from the cord and to slightly shrink the gingiva 122—thus aiding in the further exposure of the lower circumference of the tooth (to an extend of 2-7 mm, typically). In the figure, beneath cord 128, there is shown the periodontal ligament (PDL) 126 that connects the tooth 120 to the alveolar bone 124.

Whether cord 128 has been used or not, bur/file guide 110/110a/110c may be positioned over tooth 120 such that its bottom circumference fits within the gingival sulcus, protecting the gingiva 122 from bur or file 118b. Accordingly, the bottom circumference of bur/file guide 110/110a/110c may have a pointed configuration, such that it fits within the gingival sulcus around the tooth 120.

Optionally, instead of using cord 120 or in addition to using such cord, the bottom circumference of bur/file guide 110/110a/110c may contain a blood vessel constriction agent which transfers to the gingiva upon contact. For example, the pointed bottom area of bur/file guide 110/110a/110c may porous and/or hydrophilic, such that it can retain the blood vessel constriction agent until contact with the gingiva is established and the agent transfers to the gingiva and acts to constrict its blood vessels and deepen the gingival sulcus.

Each of the bur/file guides may be made of one or more materials such as plastics, metals, and ceramics. Exemplary plastics include ABS (Acrylonitrile Butadiene Styrene), PLA (Polylactic Acid), Carbon Fiber PLA, PVA (Polyvinyl Alcohol), PET (Polyethylene Terephthalate), PETG (Glycol-modified PET), PETT (Polyethylene coTrimethylene Terephthalate), HIPS (High Impact Polystyrene), Polyamide (“Nylon”), Amphora 3D, ASA (Acrylonitrile Styrene Acrylate), and others. Exemplary metals include stainless steel, cobalt-chrome alloy, titanium, nickel-titanium alloy (nitinol), and others.

Each of the bur/file guides may be fabricated specifically for the certain patient using the computer-controlled rapid manufacturing machine. To generate a CAM file and/or a 3D model for each of the bur/file guides, the specialized software may include program code characterizing various types of bur/file guides, from which the software operator may choose the types applicable to the planned treatment. For example, the software may present to the operator one or more of the following bur/file guides: A bur guide for drilling of a top opening in a tooth; a bur guide for removing infected tissue from the upper areas of the root canals while widening these areas; a file guide for cleaning the lower areas of the root canals from infected tissue; a bur guide for reshaping a tooth's crown to prepare a shoulder for artificial crown mounting; a bur guide for removing a top layer of a tooth's crown, to lower the tooth; a bur guide for drilling and cleaning a decayed region of a tooth, in preparation for a filling; and any other guide configured to guide a handpiece-mounted effector (bur, file, or other) along a treatment path in the dental anatomy. Each of these bur/file guide types may be provided, in the software, as software instructions that characterize both the general external design of the guide (that has to snugly fit in base 102, in the correct location over the treated tooth), and a set of rules that dictate how its internal design (of the guidance channel(s)) should be designed.

Once the software operator selects the applicable type or types of bur/file guides, the software may automatically or semi-automatically design the guide internally, namely —its elongated slot, its tubular channel(s), etc. This may be performed respective of the planned treatment and the 3D model of the treated tooth—both of its external surface curvature and its internal structure (enamel, dentin, pulp cavity, root canals, and/or the like), and optionally also of its surrounding anatomy (gum tissue, nerves and blood vessels, bone, and/or the like). For example, responsive to a selection by the software operator of the treated tooth and the required treatment, the software may automatically analyze the 3D model of that tooth (and optionally of its immediate surroundings) and propose a design for cach of the bur/file guides that are to be fabricated, based on the aforementioned ruleset.

When the treatment selected by the software operator includes tooth reshaping in preparation for the mounting of an artificial crown, the specialized software optionally also enables the operator to design the artificial crown. The operator may design the shape of the crown using a GUI showing a simulation of the designed crown over the treated tooth. Once this design is ready, the specialized software may automatically generate a design for a suitable bur guide, that is structured to guide a bur to create a circumferential shoulder that will precisely fit the designed crown. The specialized software may output a CAM file with the crown design, which may then be fed into a rapid manufacturing machine, such as a CNC miller, in order to fabricate the crown.

As an alternative to designing the artificial crown in the specialized software, a 3D model of the artificial crown, designed by a different software product, may be provided to the specialized software for the purpose or generating a corresponding design for a bur guide.

In a typical endodontic treatment of a molar, a premolar, or a canine, at least some of the following bur/file guides may be used: a bur guide with a single channel for drilling a top opening in the tooth; a bur guide with a number of channels corresponding to the number of root canals, for cleaning and widening the upper parts of the root canals; a file guide with a number of channels corresponding to the number of root canals, for cleaning and filing the lower parts of the root canals. In endodontic treatments that also require an artificial crown, the following two types of bur guides may also be used in preparation for the mounting of the artificial crown: a pair of complementary bur guides for removing a top layer of the tooth in order to reduce its height; and a pair of complementary bur guides for forming a shoulder at the circumference of the tooth, in preparation for the mounting of an artificial crown. The last two types of bur guides may also be useful in any other (non-endodontic) type of treatment where an artificial crown is required, for example when the natural crown had extended areas of decay that were removed, and the tooth cannot be reasonably restored with direct restorative materials (i.e., a filling).

Since incisors are typically convex along their vertical axis, certain reshaping procedures of an incisor may benefit from three different bur guides used sequentially to remove tooth material from the side of the tooth's anatomical crown: A first bur guide configured to guide a bur to remove that tooth material from approximately the top (incisal) third of the anatomical crown; a second bur guide configured to guide a bur to remove tooth material from approximately the middle third of the anatomical crown; and a third bur guide configured to guide a bur to remove tooth material from approximately the bottom (cervical) third of the anatomical crown. Each of these three bur guides may be configured to position the bur(s) substantially parallel to the side surface of the anatomical crown, to facilitate the reshaping.

With reference back to FIGS. 1A-1G, assembly 100 may be configured with multiple, predefined degrees of freedom: Hinge 106 and axle 109 jointly provide arm 108 with rotational freedom around the central axis of the axle, which is optionally parallel or substantially parallel to the vertical axis of assembly 100; arm 108, due to its telescopic configuration, has translational freedom along its longitudinal axis; and arm 108, with bore 108c through which the bur/file is inserted, endows the bur/file with translational freedom along central axis, which is set to be parallel or substantially parallel to the vertical axis of assembly 100 for some types of treatment, or at a certain sharp angle with the vertical axis in some other types of treatment. With respect to that last degree of freedom, any of the bur/file guides may cooperate with arm 108 to ensure that the bur/file stably translates only along the set axis.

Described above were three degrees of freedom of assembly 100. In certain configurations thereof, the assembly may have a different number of degrees of freedom, such as one, two, four, or five degrees of freedom.

Assembly 100 may be configured to allow virtually no lash (also “play” or “free play”) of its parts beyond the aforementioned degrees of freedom, for example providing for a lash of only up to 0.05-0.7 mm in all axes for each part.

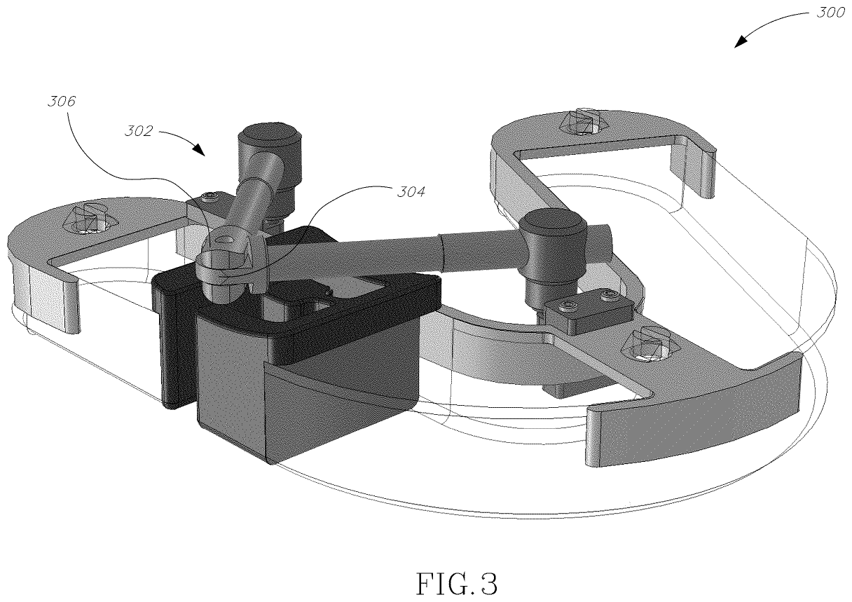

Reference is now made to FIG. 3, which is a front perspective view of another exemplary configuration of an assembly 300. Assembly 300 may be similar to assembly 100 of FIGS. 1A-1G, except for the following differences: Assembly 300 may include two arms instead of one, to enhance stability of handpiece guidance. The additional arm may be pivotally connected to an additional hinge, and both are indicated generally in the figure with reference numeral 302.

The hinges of the two arms are optionally secured to the frame at equal or similar distances from the treated tooth, so as to divide the moment applied by the handpiece more or less equally between the hinges and arms. The locations at which the two hinges are secured to the frame may also be determined subject to other considerations or constraints.

Another difference between assembly 300 and assembly 100 of FIGS. 1A-1G, is that the handpiece interfaces of the two arms of assembly 300 are configured to cooperate in the guiding of the bur or file. For example, the handpiece interfaces may have interleaved mating structures 304 and 306 that prevent them from vertically separating, and co-aligned vertical apertures through which the bur or file is inserted and prevents the handpiece interfaces from separating horizontally.

Reference is now made to FIGS. 4A-4B, which are a front perspective view and an exploded perspective view, respectively, of another exemplary configuration of an assembly 400. Assembly 400 may be similar to assembly 300 of FIG. 3, except for the following: One difference is that, instead of using a frame one which one or more hinges are mounted, assembly 400 includes more massive clamps 406 and 408 that are secured to the base more elaborately, and each includes a hinge to support an arm 402 or 403, respectively. Notably, while FIGS. 4A-4B show two clamps and two arms, other configurations (not shown) may include only one such clamp and one respective arm, resembling the configuration discussed above with reference to FIGS. 1A-1G but with a clamp instead of a hinge and without a reinforcement frame.

Each of clamps 406 and 408 may have a general U shape that presses on the base from two opposing surfaces—its front surface and its rear surface. For example, with reference to clamp 406, it may include a front, L-shaped clamp part 406a that is fastened to a rear, L-shaped clamp part 406b using a pair of fastening screws 406c. Clamp 408 is optionally similarly structured. Each of clamps 406 and 408 may be sized such that it does not protrude from the base downwardly and injure the gums.

The base, in this configuration, may include recesses in its front, rear, and/or upper surfaces that are sized and shaped to snugly receive clamps 406 and 408. For example, with respect to clamp 408 that is positioned relatively distally on the base, where the thickness of the base may be lesser that at its more mesial area, only a front surface recess 410a and a rear surface recess 410b may be provided. Regarding clamp 406 that is positioned more mesially, the base at that location may include a generally U-shaped recess 412 extending over its rear, upper, and front surfaces. Optionally, any rear and front recesses have a depth which is equal to or greater than a thickness of the clamp at these areas, so that the clamp does not protrude from the base and injure the cheeks.

Another difference between assembly 400 and assembly 300 of FIG. 3 is that the base in assembly 400 is fabricated as a unitary piece of material, with at least a vertical wall 410 abridging the areas of the base on the two sides of the void 102e. Vertical wall 410 may have thickness, for example, of between 1-4 mm or beyond.

It is explicitly intended herein that aspects of the configurations of FIGS. 1A-1G, 3, and 4A-4B be combined, to form additional configurations. Merely as an example, the frame and hinge of FIGS. 1A-1G may be combined with the unitary base of FIG. 4, or the clamps of FIGS. 4A-4B may be combined with the two-piece base of FIGS. 1A-1G. Such combinations may sometime require minor modifications to the described structure, which will become immediately apparent to those of skill in the art.

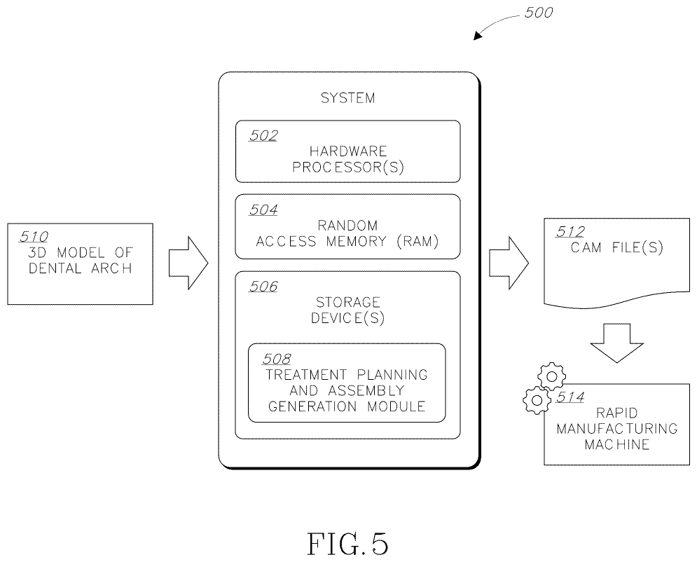

Reference is now made to FIG. 5, which shows a block diagram of an exemplary system 500 for dental treatment planning and generation of patient-specific dental guidance assemblies. System 500 may include one or more hardware processor(s) 502, a random-access memory (RAM) 504, and one or more non-transitory computer-readable storage device(s) 506.

Storage device(s) 506 may have stored thercon program instructions and/or components configured to operate hardware processor(s) 502. The program instructions may include one or more software modules, such as a treatment planning and assembly generation module 108, which is optionally the specialized software discussed above. The software components may include an operating system having various software components and/or drivers for controlling and managing general system tasks (e.g., memory management, storage device control, power management, etc.), and facilitating communication between various hardware and software components.

System 500 may operate by loading instructions of module 508 into RAM 504 as they are being executed by processor(s) 502. The instructions of module 108 may cause system 500 to receive (or generate) a 3D model of patient's dental arch, process it in accordance with a treatment plan, and output one or more CAM files 512 that can be fed into a rapid manufacturing machine in order to manufacture one or more parts of an assembly.

System 500 as described herein is only an exemplary configuration of the present invention, and in practice may be implemented in hardware only, software only, or a combination of both hardware and software. System 500 may have more or fewer components and modules than shown, may combine two or more of the components, or may have a different configuration or arrangement of the components. System 500 may include any additional component enabling it to function as an operable computer system, such as a motherboard, data busses, power supply, a network interface card, a display, an input device (e.g., keyboard, pointing device, touch-sensitive display), etc. (not shown). Moreover, components of system 500 may be co-located or distributed, or the system could run as one or more cloud computing “instances,” “containers,” and/or “virtual machines,” as known in the art.

The instructions of module 508 are now discussed with reference to a computerized method for treatment planning and generation of a patient-specific dental guidance assembly. First, a 3D model of the specific patient's dental arch may be received, such as from a dental imaging center, or the model can be generated by system 500 itself. The 3D model may be based, for example, on CBCT imagery that shows the internal structure of the teeth as well as their external curvature, and optionally also on a 3D scan (e.g., camera- or laser-based scan) of the dental arch that provides the external curvature of the teeth at sometimes a better accuracy than the CBCT. A further option is to base the 3D model on a 3D scan of the dental arch and on X-Ray images of the treated tooth from multiple angles, which are utilized for reconstructing a volumetric model of that tooth. Either way, generation of the 3D model may utilize conventional techniques.

Second, the software operator may input parameters such as which tooth is to be treated and the type of treatment (e.g., root canal, filling, reshaping for artificial crown, etc.). Optionally, as to the type of treatment, the dentist may input detailed parameters defining, for example, 3D shapes of the areas in the tooth that are to be removed. The input of parameters may be performed using a Graphic User Interface (GUI) provided by module 508, which displays the 3D model and enables the software operator to make selections, annotate, draw paths, and/or the like using one or more input devices such as a touch screen, a pointing device, a keyboard, etc.

To semi-automate the input of some of the parameters, module 508 may present the software operator with suggested parameters based on an automated analysis of the 3D model and the type of treatment, and/or based on one or more earlier-input parameters that imply a subsequent parameter.

Third, based on the input parameters and the 3D model, module 508 may design one or more 3D models of parts of an assembly to be fabricated, such as a model for the assembly's base and separate models for each of its one or more bur/file guides. Additionally, module 508 may provide the software operator with a list and/or a visual illustration of additional parts that need to be assembled together to form the assembly, such as the mass-manufactured frame, hinge(s), clamp(s), axle(s), arm(s), etc. Optionally, module 508 automatically generates a graphical step-by-step instructions manual on how to assemble the necessary parts, and the order in which the bur/file guides are to be used during treatment.

The design of the part 3D models may be fully- or semi-automatic. In a fully-automatic mode, module 508 computes these part 3D models based on the input parameters and the 3D model of the dental arch, using stored program instructions that mathematically associate input parameters and an input dental arch 3D model with part structures. In a semi-automatic mode, module 508 may compute only preliminary part 3D models, which include estimated part structures, and the software operator then adjusts these structures based on what he or she observe in the dental arch 3D in conjunction with various treatment style preferences of the dentist.

Next, module 508 may generate one or more CAM files which include instructions, readable by a computer of a rapid manufacturing machine (e.g., a 3D printer or a CNC miller) 514, on how to fabricate the respective one or more assembly parts—typically the base and the bur/file guides. Alternatively, the CAM file(s) may be generated by a different computer system (not system 500), which receives a CAD file from system 500 and converts it to a CAM file readable by the pertinent rapid manufacturing machine.

Additionally, module 508 may generate assembly instructions for the assembly, which instruct the dentist exactly which parts from his or her stock, such as arms, hinges, axles, clamps, frame, etc. should be assembled with the fabricated base and bur/file guides, and in what manner these should be assembled together.

In one example, a kit may be provided, which includes at least some of the following elements: system 500 (or at least a CAD software configured to perform the actions of module 508 and optionally also generate the 3D of block 510), rapid manufacturing machine 514, and at least some of the elements of assembly 100, 400, or 500. A dentist, or any other user, may use the kit to fabricate base 102 and one or multiple ones of bur/file guide 110/110a/110c for a specific patient, mount the necessary elements of assembly 100, 400, or 500 onto or relative to the manufactured base 102, and treat the pertinent tooth using a bur and/or a file mounted to a dental rotary handpiece.

The description of a numerical range should be considered to have specifically disclosed all the possible subranges as well as individual numerical values within that range. This applies regardless of the breadth of the range. For example, description of a range of integers from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. Similarly, description of a range of fractions from 0.6 to 1.1 should be considered to have specifically disclosed subranges such as from 0.6 to 0.9, from 0.7 to 1.1, from 0.9 to 1, from 0.8 to 0.9, from 0.6 to 1.1, from 1 to 1.1 etc., as well as individual numbers within that range, for example, 0.6, 0.7, 0.8, 0.9, 1, and 1.1.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the description and claims of the application, each of the words “comprise,” “include,” and “have,” as well as forms thereof, are not necessarily limited to members in a list with which the words may be associated. In addition, each of the terms “substantially,” “essentially,” and forms thereof, when describing a numerical value, mean up to a 20% deviation (namely, +20%) from that value; similarly, when such a term describes a numerical range, it means an up to 20% broader range (10% on each side of the range).

In addition, where there are inconsistencies between this application and any document incorporated by reference, it is hereby intended that the present application controls.

1. A dental guidance assembly comprising:
a rigid arcuate base configured to snugly fit over a dental arch of a specific human subject;
a hinge fixedly mountable relative to said rigid arcuate base;
an arm having a proximal side and a distal side, said arm being pivotally connectable at its proximal side to said hinge, and configured to support, at its distal side, a dental rotary handpiece; and
an exchangeable bur or file guide configured to snugly fit in said rigid arcuate base, said bur or file guide comprising a channel that is configured to guide a bur or a file mounted on the dental rotary handpiece along a preplanned treatment path in a treated tooth of the dental arch of the specific human subject.

2. The dental guidance assembly of claim 1, further comprising:
a rigid reinforcement frame configured to snugly fit over said rigid arcuate base,
wherein said hinge is fixedly mountable on said rigid reinforcement frame.

3. The dental guidance assembly of any one of claim 1, comprising multiple ones of said exchangeable bur or file guide.

4. The dental guidance assembly of claim 3, wherein said multiple exchangeable bur or file guides are two or more of:
a first exchangeable bur or file guide whose channel is a tubular channel configured to limit motion of the bur or file to linear drilling or filing into the treated tooth;
a second exchangeable bur guide whose channel is an elongated slot configured to limit motion of the bur to circumferential cutting of a crown of the treated tooth;
a third exchangeable bur guide whose channel is a wide tubular channel configured to limit motion of the bur to removal of an upper layer of the crown of the treated tooth; or
a fourth exchangeable bur guide whose channel is a wide tubular channel configured to limit motion of the bur to drilling of an upper opening in the crown of the treated tooth,
wherein the dental guidance assembly is configured for exchanging of said multiple exchangeable bur or file guides by one another while said rigid arcuate base, optionally said rigid reinforcement frame, said hinge, and said arm are assembled together and are secured intraorally.

5. The dental guidance assembly of claim 1, wherein said arm further comprises a dental rotary handpiece interface at its distal side, said interface configured to interface with a head of the dental rotary handpiece.

6. The dental guidance assembly of claim 1, wherein:
said hinge is a first hinge;
said arm is a first arm; and
the dental guidance assembly further comprises:
a second hinge fixedly mountable relative to said rigid arcuate base, and
a second arm having a proximal side and a distal side, said second arm being pivotally connectable at its proximal side to said second hinge, and being configured to support, at its distal side, the dental rotary handpiece.

7. The dental guidance assembly of claim 1, wherein:
said rigid arcuate base includes a void where a tooth to be treated is to be located when said rigid arcuate base is fit over the dental arch; and
said exchangeable bur or file guide is configured to snugly fit in said void.

8. A method for using the dental guidance assembly of claim 1, comprising:
fixedly mounting said hinge relative to said rigid arcuate base;
pivotally connecting said arm, at its proximal side, to said hinge;
snugly fitting said rigid arcuate base over the dental arch of the specific human subject;
snugly filling said exchangeable bur or file guide in said rigid arcuate base; and
while the dental rotary handpiece is supported by the arm and optionally by the second arm, guiding the bur or the file is said channel, to treat the tooth along the preplanned treatment path.

9. A kit comprising:
(a) a computer-aided design (CAD) software provided on a non-transitory computer-readable storage medium having program code embodied therewith, the program code executable by at least one hardware processor to:
obtain a three-dimensional (3D) model of a dental arch of a human subject, the dental arch including a tooth to be treated;
generate, respective of the 3D model of the dental arch, a 3D model of an arcuate base configured, once fabricated, to snugly fit over the dental arch, the arcuate base having a void where the tooth is to be located when the arcuate base is fit over the dental arch;
generate, respective of the 3D-modeled tooth and of a treatment plan, a 3D model of an exchangeable bur or file guide configured, once fabricated, to snugly fit in the fabricated arcuate base, wherein the 3D model of the bur or file guide comprises a channel that is configured, once fabricated, to guide a bur or a file mounted on a dental rotary handpiece along a preplanned treatment path in the tooth;
(b) one or more rapid manufacturing machines configured to fabricate the arcuate base and the exchangeable bur or file guide based on the 3D models of the arcuate base and the exchangeable bur or file guide, respectively;
(c) a hinge fixedly mountable relative to said arcuate base; and
(d) an arm having a proximal side and a distal side, said arm being pivotally connectable at its proximal side to said hinge, and configured to support, at its distal side, a dental rotary handpiece.

10. The kit of claim 9, further comprising:
a rigid reinforcement frame configured to snugly fit over said arcuate base,
wherein said hinge is fixedly mountable on said rigid reinforcement frame.

11. The kit of claim 9, comprising multiple ones of said exchangeable bur or file guide.

12. The kit of claim 11, wherein said multiple exchangeable bur or file guides are two or more of:
a first exchangeable bur or file guide whose channel is a tubular channel configured to limit motion of the bur or file to linear drilling or filing into the tooth;
a second exchangeable bur guide whose channel is an elongated slot configured to limit motion of the bur to circumferential cutting of a crown of the tooth;
a third exchangeable bur guide whose channel is a wide tubular channel configured to limit motion of the bur to removal of an upper layer of the crown of the tooth; andor
a fourth exchangeable bur guide whose channel is a wide tubular channel configured to limit motion of the bur to drilling of an upper opening in the crown of the tooth,
wherein said arcuate base is configured for exchanging of said multiple exchangeable bur or file guides by one another while said arcuate base, optionally said rigid reinforcement frame, said hinge, and said arm are assembled together and are secured intraorally.

13. The kit of claim 9, wherein said arm further comprises a dental rotary handpiece interface at its distal side, said interface configured to interface with a head of the dental rotary handpiece.

14. The kit of claim 9, wherein:
said hinge is a first hinge;
said arm is a first arm; and
the kit further comprises:
a second hinge fixedly mountable relative to said arcuate base, and
a second arm having a proximal side and a distal side, said second arm being pivotally connectable at its proximal side to said second hinge, and being configured to support, at its distal side, the dental rotary handpiece.

15. A method for designing said rigid arcuate base and said exchangeable bur or file guide of claim 1, comprising operating a computer-aided design (CAD) software to:
obtain a three-dimensional (3D) model of the dental arch of a human subject, the dental arch including the tooth to be treated;
generate, respective of the 3D model of the dental arch, a 3D model of said rigid arcuate base;
generate, respective of the 3D-modeled tooth and of a treatment plan, a 3D model of said exchangeable bur or file guide.

16. (canceled)
